(19) United States
(12) Patent Application Publication
(10) Pub. No.: US 2016/0136681 A1
(43) Pub. Date: May 19, 2016

(54) NANOPARTICLE COATED SUBSTRATES AND METHOD OF MAKING THE SAME

(71) Applicant: EBO USA INC., Cambridge, MA (US)

(72) Inventors: CHAO-LUN MAI, Cambridge, MA (US); CHU-YUN HUANG, Cambridge, MA (US)

(21) Appl. No.: 14/944,220

(22) Filed: Nov. 18, 2015

Related U.S. Application Data
(60) Provisional application No. 62/081,415, filed on Nov. 18, 2014.
(60) Provisional application No. 62/081,444, filed on Nov. 18, 2014.
(60) Provisional application No. 62/081,450, filed on Nov. 18, 2014.

(51) Int. Cl. B05D 1/40; B05C 9/02; B05D 3/00

(52) U.S. Cl. CPC B05D 1/40; B05D 3/007; B05C 9/02

(57) ABSTRACT

An apparatus for applying nanoparticles to a surface of a substrate is provided. The apparatus includes a support member, a deposition plate extending from the support member, and a platform baying a surface for receiving a substrate. The deposition plate defines a plurality of channels therein. The channels have at least one inlet and a plurality of outlet ports.

### FIELD

The subject matter herein relates to nanoparticle coated substrates and a method of continuously coating a substrate surface with nanoparticles.

### BACKGROUND

Thin film technology, wherein organic or inorganic particles with sizes on the order of 1-1000 nm are arranged in layers to form a film, is currently being used for an increasingly large number of different technological applications, including: information storage and transmission systems, chemical and biological sensors, optical and photonic devices, catalytic supports, energy harvesting and storage devices, thermal management devices, and other various products having surface property modification functionalities.

### BRIEF DESCRIPTION OF THE DRAWINGS

Implementations of the present technology will now be described, by way of example only, with reference to the attached figures.

FIG. 1 is a side plan view of an exemplary nanoparticle deposition apparatus.

FIG. 2 is a side plan view of another exemplary nanoparticle deposition apparatus.

FIG. 3 is a diagrammatic view illustrating the application of nanoparticles onto a surface of a substrate using the apparatus of FIG. 1 wherein the deposition plate is contacting a substrate.

FIG. 4 is a diagrammatic view illustrating the application of nanoparticles onto a surface of a substrate using the apparatus of FIG. 1, wherein the deposition plate is suspended above substrate.

FIG. 5 is a free body diagram illustrating forces present during application of nanoparticles onto a substrate.

FIG. 6 is another free body diagram illustrating forces present during application of nanoparticles onto a substrate.

FIG. 7 is an exemplary embodiment of a deposition plate defining a plurality of channels therein.

FIG. 8 is another exemplary embodiment of a deposition plate defining a plurality of channels therein.

FIG. 9 is a diagrammatic view illustrating the application of nano particles onto a surface of a substrate using the apparatus of FIG. 2.

FIG. 10 is an exemplary embodiment of a curved deposition plate defining a plurality of channels therein.

FIG. 11 is another exemplary embodiment of a curved deposition plate defining a plurality of channels therein.

FIG. 12 is an exemplary embodiment of a nanoparticle thin film formed on a substrate.

FIG. 13 is a Scanning Electron Microscope (SEM) image of a nanoparticle monolayer disposed on a substrate.

FIG. 14 is an SEM image of another nanoparticle monolayer disposed on a substrate.

FIG. 15 is a diagrammatic view illustrating the application of nanoparticles onto a surface of a substrate using another exemplary deposition plate.

FIG. 16 is an exemplary cylindrical nanoparticle thin film coated substrate using the deposition plate illustrated in FIG. 15.

FIG. 17 illustrates an exemplary embodiment similar to the one illustrated in FIG. 15, but the embodiment illustrated in FIG. 17 includes a gap formed between the deposition plate and the substrate.

FIG. 18 illustrates a cross sectional view with a space and a gap being illustrated.

FIG. 19 illustrates a planar example having channels formed in the deposition plate. The deposition plate can be formed so as to include the channels.

FIG. 20 illustrates the implementation as illustrated in FIG. 19, but in a substantially conical configuration like that of FIGS. 15 and 17 as described above.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the examples described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The term “nanoparticles” as described herein, means any particle having a diameter ranging from 1-1000 mm.

The present disclosure is described in relation to an apparatus for applying nanoparticles to a surface of a substrate. The present disclosure is further described in relation methods of using the apparatus disclosed herein for making nanoparticle coated substrates. Nanoparticle coated substrates produced in relation to the disclosed apparatus and methods are also disclosed herein.

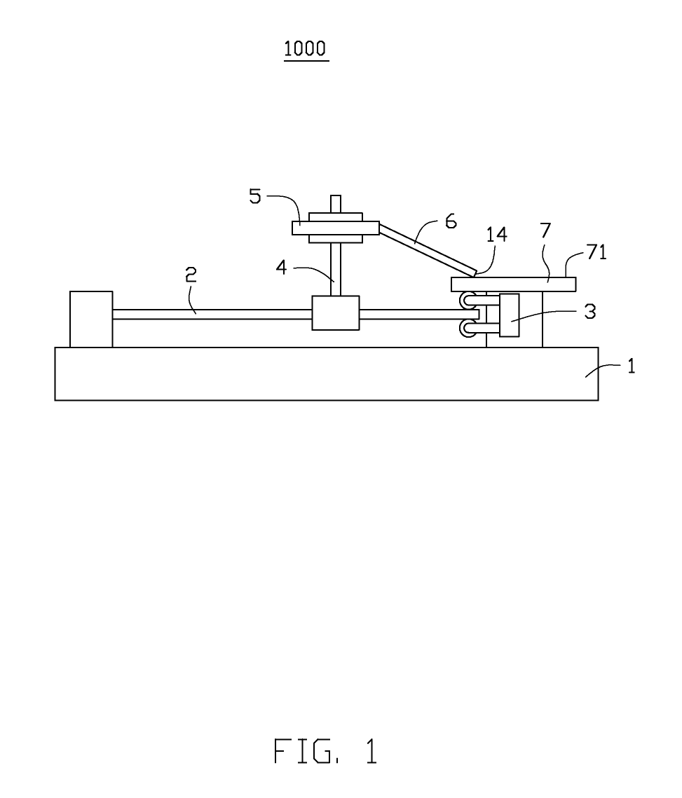

FIG. 1 illustrates an exemplary nanoparticle deposition apparatus 1000 for forming a nanoparticle thin film on a substrate. The deposition apparatus 1000 generally comprises a support member 4 coupled to a motor 3, a deposition plate 6 extending from the support member 4, a platform 7 haying a flat surface 71 for receiving a substrate (not shown), the deposition plate 6 extending toward the flat surface 71 of the platform 7 at an acute angle. The motor 3 is configured to drive the support member 4 toward the deposition plate 6 such that an end 14 of the deposition plate 6 moves across the flat surface 71 of the platform 7, whereby nanoparticles are distributed along the surface of a substrate when received on the flat surface 71 of the platform 7. The general components described above are represented in FIG. 1 as follows. As shown in FIG. 1, the deposition apparatus 1000 can be mounted on a base 1 to secure the deposition apparatus 1000 for use. The deposition apparatus 1000 further comprises a drive shaft 2 and a clamp 5. The support member 4 is moveably coupled to the drive shaft 2 and extends perpendicularly from the drive shaft 5. The clamp 5 is mounted on the support member 4. The motor 3 is attached to the base 1. The motor 3 can actuate the support member 4 to move along the length of the drive shaft 2. The motor 3 can be mechanical, electronic, electromagnetic, or any other suitable type of motor. The deposition plate 6 and the clamp 5 can be configured such that the deposition plate 6 couples to the clamp 5. The platform 7 can be coupled to a top surface of the motor 3 for receiving a substrate (not shown) on which nanoparticles will be deposited.

In use, the deposition apparatus 1000 is designed such that a substrate is placed on the platform 7 and the deposition plate 6 extends toward the flat surface of the platform 7 at an acute angle and contacts the substrate surface. Preferably, the deposition apparatus 100 is configured such that the acute angle formed by the substrate and deposition plate 6 is greater than 25 degrees, more preferably greater than 45 degrees, and even more preferably the acute angle is 60 degrees. The acute angle can be changed by, for example, altering the overall height of the support member 4 relative to the platform 7. Alternatively, the acute angle can be changed by moving the clamp 5 to different locations of the support member 4. In other words, as the clamp 5 is moved higher vertically on the support member 4, the acute angle will be increased.

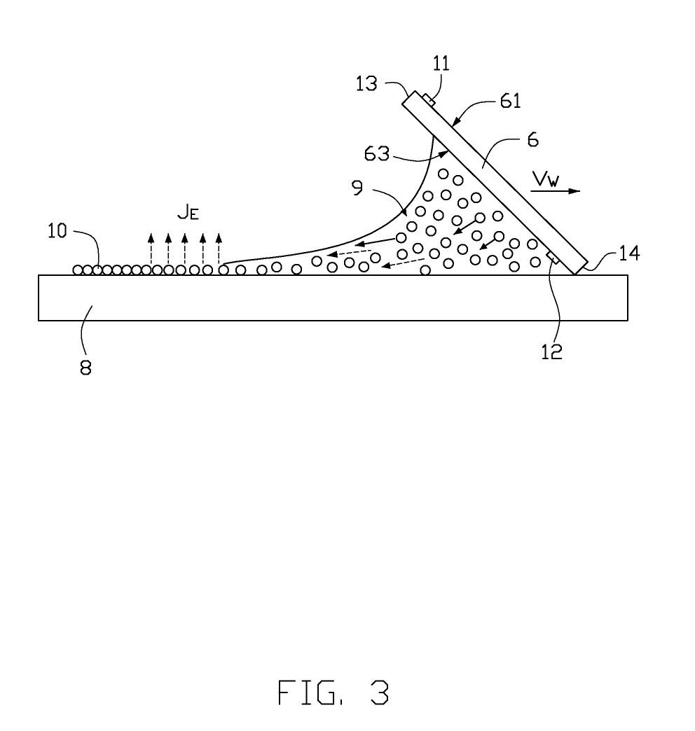

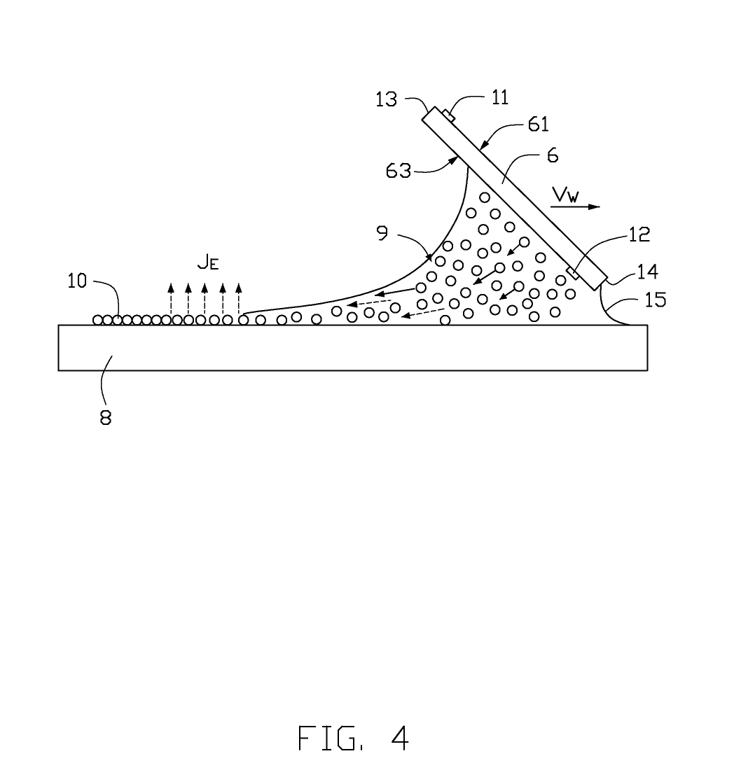

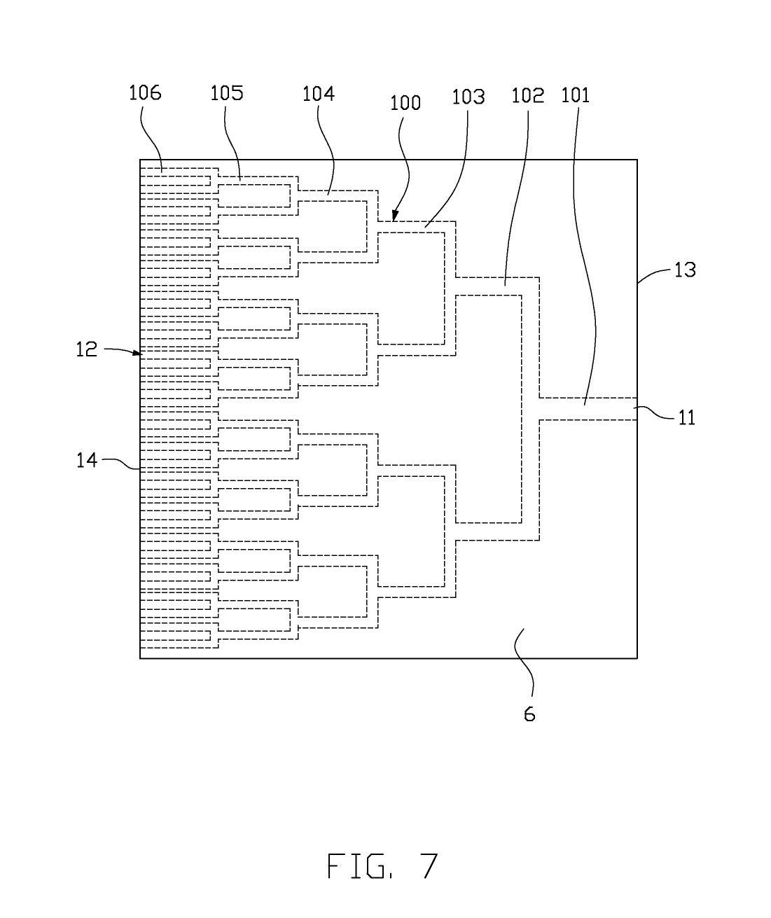

Furthermore, an inlet 11 can be provided on a top surface 61 proximate the upper end 13 of the deposition plate 6 as shown in FIGS. 3 and 4. A plurality of outlet ports 12 (shown in detail in FIG. 7) can be provided on an under surface 63 of the deposition plate 6 near the lower end 14 of the deposition plate 6. A suspension can be provided in the inlet 11, and which passes through channels 100 (described in FIG. 7) in the deposition plate 6 and exits out from the outlet ports 12. The suspension can then coat as substrate provided beneath the deposition plate 6. The cross-sectional are of channels 101-106 follows Murray's law, such that the flow at the outlets ports 12 is substantially homogenous, and the flow direction is mainly parallel to the direction of nanoparticle accumulation on the substrate.

In one example, the deposition apparatus 1000 can be used to form a nanoparticle thin film wherein the thin film is a nanoparticle monolayer. In other examples, deposition apparatus can be used to form a nanoparticle thin film wherein the thin film has more than one nanoparticle layer.

In one example, the deposition apparatus 1000 can be used to form a nanoparticle thin film wherein the thin film is a nanoparticle monolayer. In other examples, deposition apparatus can be used to form a nanoparticle thin film wherein the thin film has more than one nanoparticle layer.

In one exemplary embodiment, the deposition plate 6 physically contacts the substrate when in use. In alternative embodiments, the deposition plate 6 can be suspended above the substrate at while still forming the acute angle. In at least one embodiment, the deposition plate 6 is suspended up to 0.5 mm above the substrate surface. In other embodiments, the deposition plate 6 is suspended from about 40 μm to about 0.5 mm above the substrate surface. The deposition plate 6 can be made of a metal, a metal alloy, a silicon oxide, a plastic, or any combination thereof.

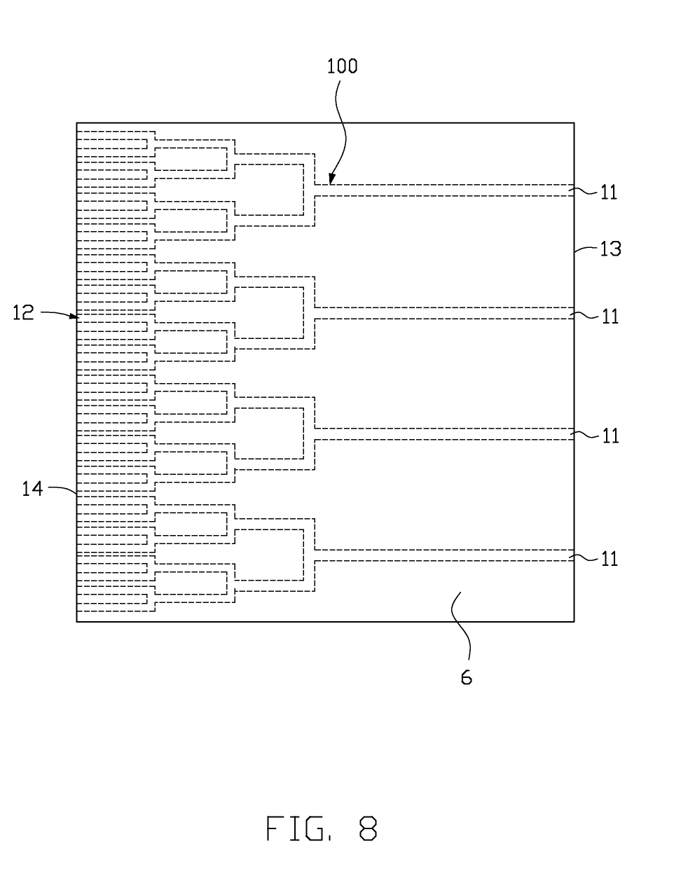

The deposition plate illustrated in FIGS. 7 and 8 can also be made of a plastic, rubber, polymer or other deformable material such as, fir example polydimethylsilicon (PDMS). The deformable deposition plate can be fabricated by any method commonly used by one of ordinary skill in art such as, for example, injection molding or other lithographic methods to solidify and crosslink certain parts of the deformable material while allowing the materials in the defined channel region to be removed. After injection molding or a lithographic process, the deformable deposition plate can be cured for a predetermined period of time. The amount of curing time can be varied to finely tune the degree of softness or hardness of the deposition plate. The deformable deposition plate can be formed into a shape corresponding to the shape of any substrate surface for deposition of nanoparticles. The deformable deposition plate can be formed to have, for example, a convex surface, and concave surface, and rippled or ridged surface. an oscillating series of local minima and maxima, or any other suitable shape.

In at least one embodiment, the deposition plate 6 and clamp 5 can be coupled such that an angle formed between the deposition plate 6 and clamp 5 is constant. In other embodiments, the deposition plate 6 and clamp 5 can be pivotably coupled such that an angle formed between the deposition plate 6 and clamp 5 can be changed during prior to or during use. The pivotable coupling can be independently changed by the user or can be changed in response to modification of the support member 4 and the clamp 5 as described above.

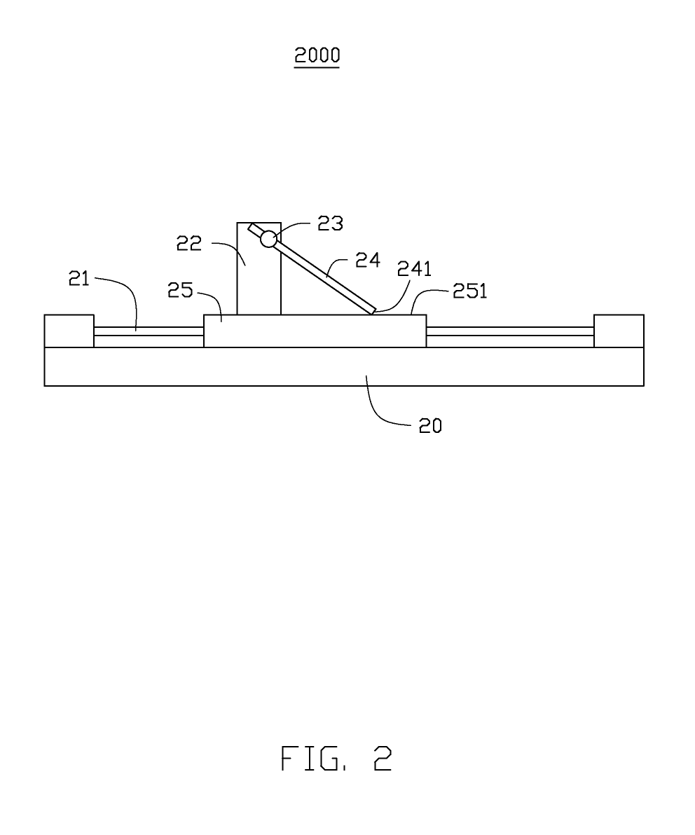

FIG. 2 illustrates another exemplary nanoparticle deposition apparatus 2000 for forming a platform thin film on a substrate. The deposition apparatus 2000 generally comprises a platter 25 coupled to a motive force (for example, a motor) via a drive shaft 21 and having a flat surface 251 for receiving a substrate (not shown), a deposition plate 24 extending from a support member 22, the deposition plate 24 extending toward the flat surface 251 of the platform 25 at an acute angle. The motive force is configured to drive the platform toward the deposition plate such that an end 241 of the deposition plate 24 moves across the flat surface 251 of the platform 25, whereby nanoparticles are distributed along the surface of a substrate (not shown) when received on the flat surface 251 of the platform 25. The general components described above are represented in FIG. 2 as follows. As shown in FIG. 2, the deposition apparatus 2000 can be mounted on a base 20 to secure the deposition apparatus 2000 for use. The platform 25 is moveably mounted on a drive shaft 21. The platform 25 is coupled to a motive force (not shown) which can actuate the platform 25 to move along the length of the drive shaft 21. The motive force can be mechanical, electronic, electromagnetic, or any other suitable type of motor. The deposition apparatus 2000 further comprises a clamping member 23 mounted on the support member 22. The deposition plate 24 and the clamping member 23 can be configured such that the deposition plate 24 couples to the clamping member 23. The support member 22, which is coupled to the base 20, secures the deposition plate 24 via the clamping member 23.

In use, the deposition apparatus 2000 is designed such that a substrate is placed on the platform 25 and the deposition plate 24 extends toward the fiat surface 251 of the platform 25 at an acute angle and contacts with the substrate surface. Preferably, the deposition apparatus 200 is configured such that the acute angle formed by the substrate and deposition plate 24 is greater than 25 degrees, more preferably greater than 45 degrees, and even more preferably the acute angle is 60 degrees. The acute angle can be changed by, for example, altering the overall height of the support member 22 relative to the platform 25. Alternatively, the acute angle can be changed by moving the clamping member 23 to different locations of the support member 22. In other words, as the clamping member 23 is moved higher vertically on support member 22, the acute angle will be increased.

Furthermore, the deposition plate 24 shown in FIG. 2 is substantially similar to deposition plate 6 as shown in FIGS. 7-8. The deposition plate 24 may also define a plurality of channels having at least one inlet and a plurality of outlet ports.

In one embodiment, the deposition apparatus 2000 can be used to form a nanoparticle thin film wherein the thin film is a nanoparticle monolayer. In other embodiments, deposition apparatus can be used to form a nanoparticle thin film wherein the thin film has more than one nanoparticle layer.

In at least one embodiment, the deposition plate 24 and the clamping member 23 can be coupled such that an angle formed between the deposition plate 24 and the clamping member 23 is constant. In other embodiments, the deposition plate 24 and the clamping member 23 can be pivotably coupled to the support member 22 such that an angle formed between the deposition plate 24 and the clamping member 23 can be changed prior to or during use The pivotable coupling can be independently changed by the user or can be changed in response to modification of the support member 24 and clamping member 23 as described above.

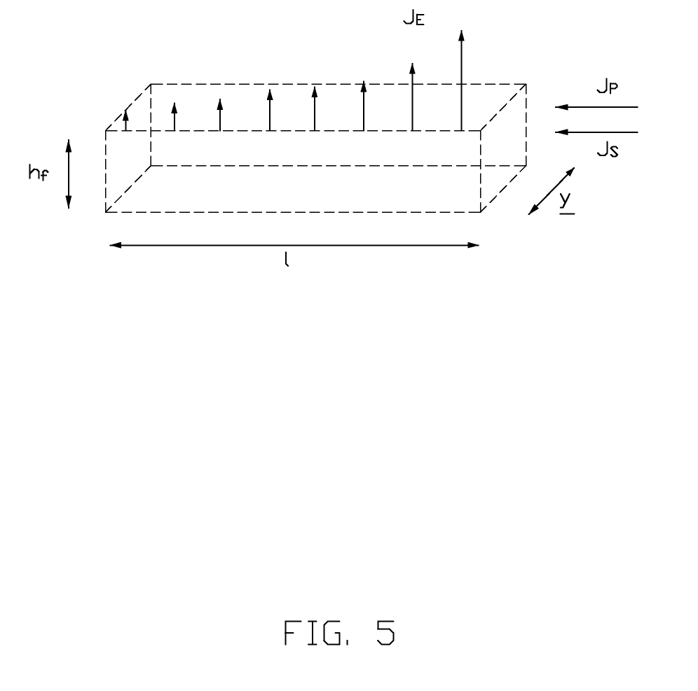

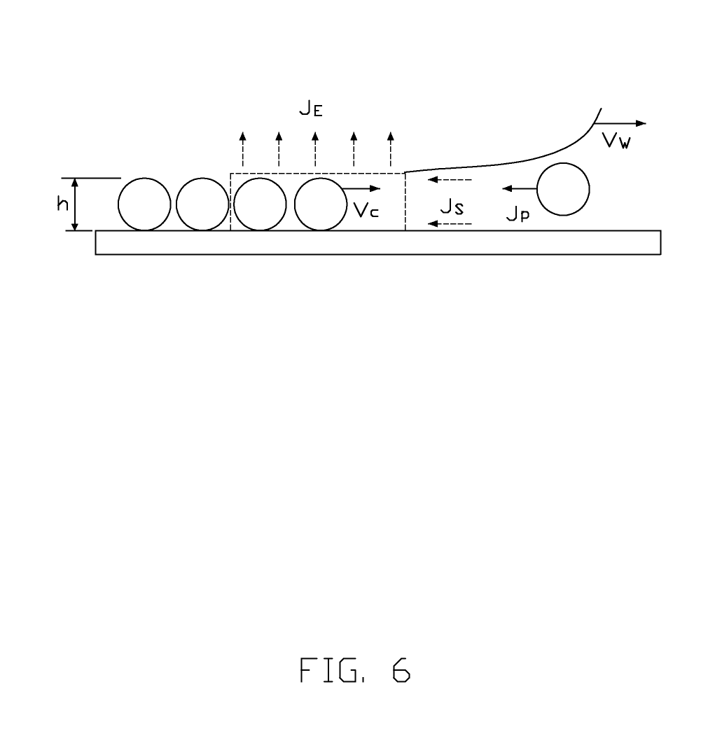

FIG. 3 is a diagrammatic view illustrating the application of nanoparticles onto a surface of a substrate 8. In use, the deposition plate 6 is placed in contact with the substrate 8 at an acute angle. A predetermined amount of a suspension 9 comprising a solvent and nanoparticles is placed in the acute angle formed between the deposition plate 6 and the substrate 8. The suspension 9 is attracted to the surfaces of the deposition plate 6 and the substrate 8 by capillary force. The deposition plate 6 is then moved along the surface of the substrate 8 from the left hand portion of the substrate toward the right hand portion of the substrate at a predefined coating speed V_{w}. As the deposition plate 6 is moved along the substrate 8, the solvent will evaporate as defined by J_{E}, the flux of the evaporating solvent, leaving a nanoparticle thin film 10. The forces and interactions leading to formation of the thin film 10 are described below in view of FIGS. 5 and 6.

As discussed above, in one exemplary embodiment, the deposition plate 6 physically contacts the substrate 8 when in use as shown in FIG. 3. In alternative embodiments, the deposition plate 6 can be suspended above the substrate 8 at while still forming the acute angle as shown in FIG. 4. In at least one embodiment, the deposition plate 6 is suspended up to 0.5 mm above the substrate 8 surface as shown. In other embodiments, the deposition plate 6 is suspended from about 40 μm to about 0.5 mm above the substrate 8 surface. The deposition plate 6 can be made of a metal, a metal alloy, a silicon oxide, a polymer, a plastic, or any combination thereof.

Also, as shown in FIG. 4, when the deposition plate 6 is suspended above the substrate 8, two opposite meniscuses 15 are formed between the substrate 8 and the deposition plate 6.

The nanoparticles used can be any type of nanoparticles and this disclosure is not intended to be limited for an specific type of application. In some embodiments, the nanoparticles can comprise silicon or silicon oxides. In other embodiments, the nanoparticles can comprise one or more organic polymers or organic dendrites such as polymethyl methacrylate (PMMA), poly carbonate (PC), polystyrene (PS), polyether ether ketone (PEEK), polyetherimide (PEI), or any other similar organic species. In other embodiments, the nanoparticles can be metals or inorganic oxides such as, for example, aluminum, gold, silver, copper, silicon oxide, aluminum oxide, titanium oxide, iridium tin oxide, iron oxide, zinc oxide, or any other desired metal or metal oxide composition. In yet other embodiments, the nanoparticles can be core-shell nanocomposites such as zinc sulfide or cadmium sulfide quantum dots, metal nanoparticles or metal oxide nanoparticles coated with an organic polymer or other functionality, or any other similar core-shell type nanoparticle. In yet other embodiments, the nanoparticles can comprise biological species such as proteins, enzymes, immunoglobulins, or any other suitable biological species. In yet further embodiments, the nanoparticles can comprise more than one of any of the nanoparticle type discussed above. The nanoparticles can exhibit properties specific for any use. For example, the nanoparticles can be magnetic, opto-electronic, chemiluminescent, phospholuminescent, any other desired property in application.

The solvent or solvent mixture used can be any type of solvent or solvent mixture and this disclosure is not intended to be limited for any specific type of application. In general, the solvent or solvent mixture should promote uniform dispersion of the nanoparticles in the suspension, be capable of evaporation under ambient or slightly elevated temperature conditions, and facilitate formation of a uniform nanoparticle monolayer. Preferably, deionized (DI) water is used. In alternative embodiments, a polar organic solvent, such as alcohols (for example, methanol, ethanol and isopropanol), dialkyl ethers (for example diethyl ether or diphenyl ether), ketones (for example, acetone) or any similar solvents can be used. In yet further alternative embodiments, mixtures of DI water, methanol, ethanol, diethyl ether, acetone or any similar solvents can be used.

FIG. 5 is a free body diagram illustrating forces present during application of nanoparticles onto a substrate. FIG. 6 is another free body diagram illustrating forces present during application of nanoparticles onto a substrate. The formation of a nanoparticle thin film layer onto a substrate surface can be understood by one of ordinary skill in the art in view of the following equations in relation to FIGS. 5 and 6. The following equations are made with the consideration that a control volume that encompasses a drying region of a thin evaporating film and the control moves as the film dries. The following equations further are modeled under the premise that the y-direction axis does not change and therefore the model can be simplified to a y-independent case. This assumption is especially true for large-area fabrication, where the width of the deposition plate (in y-direction) is large.

In the following equations J_{E} is the flux of the evaporating solvent, J_{P} is the flux of the nanoparticles, J_{S} is the flux of the solvent, y is the unit length of the substrate in the y-direction, Nₛ is the total number density of the solvent molecules, Vₛ is the volume per solvent molecule, νₛ is the flow velocity of the solvent entering the drying region, Nₚ is the total number density of the nanoparticles, Vₚ is the volume per nanoparticle, νₚ is the flow velocity of the nanoparticles entering the drying region, ν_{c} is the rate of nanoparticle accumulation, ε is the void fraction in the accumulated particle film, h_{f} is the thickness of the control volume, h is the final particle film thickness, Φ_{P} is the volume fraction of nanoparticles in the original suspension undergoing deposition, and β is correlation value.

Under steady state conditions, by conservation of volume:

J_{S}=J_{E} (1)

When the flux of the solvent and the flux of the evaporating solvent are expressed as local average fluxes the following equation can be derived:

J_{S}=y·∫₀^{h}^{_{∫}}j′ₛ(z)dz=y·∫₀^{h}^{ⱼ} N′ₛ(z)Vₛv′ₓ(z)dz=jₓh_{f}y (2)

J_{E}=y·∫₀^{∞} j′ₓ(x)dx=jₑ_{_{ly}}

where

jₛ=NₛVₛνₛ (3)

and

jₚ=NₚVₚνₚ (4)

Under the steady state approximation, the combination of equations 1 and 3 yields:

$${J}_{E} = {j}_{e} l \underline{y} = {j}_{s} {h}_{f} \underline{y} = {J}_{S} , \\ and \\ {j}_{s} = {N}_{s} {V}_{s} {v}_{s} \\ ⇒ \frac{{j}_{e} l}{{h}_{f}} = {N}_{s} {V}_{s} {v}_{s} \\ ⇒ {v}_{s} = \frac{{j}_{e} l}{{N}_{s} {V}_{s} {h}_{f}} \qquad ( 5 )$$

Because there is no exiting flux of, but rather an accumulation of nanoparticle growing at a rate of ν_{c}, equation 4 can be expressed as follows:

J_{P}=jₚh_{∫}y=NₚVₚνₚh_{∫}y, and J_{P}=ν_{c}(1−ε)hy (6)

Because the nanoparticles are dispersed in solvent, the nanoparticles will move with the solvent flow. Therefore, the particle flow rate can be considered proportional to the solvent flow rate as follows:

ν_{P}=νₓ (7)

and

N_{P}Vₚνₚh_{∫}y=NₚVₚβνₛh_{∫}y=ν_{c}(1−ε)hy (8)

The combination of equations 5 and 8 yields:

$${N}_{p} {V}_{p} β {v}_{s} {h}_{f} = {N}_{p} {V}_{p} β \frac{{j}_{e} l}{{N}_{s} {V}_{s} {h}_{f}} {h}_{f} = {v}_{c} ( 1 - ɛ ) h \\ ⇒ β {j}_{e} l \frac{{N}_{p} {V}_{p}}{{N}_{s} {V}_{s}} = {v}_{c} ( 1 - ɛ ) h \qquad ( 9 )$$

The ratio of NₚVₚ/NₛVₛ in equation 9 can be rewritten as φₚ/(1−φₚ), where φₚ is the volume fraction of particles in the original suspension being deposited, and φₛ=1−φₚ is the corresponding solvent: volume fraction, yielding:

$$β {j}_{e} l \frac{{φ}_{p}}{1 - {φ}_{p}} = {v}_{c} ( 1 - ɛ ) h , \\ ⇒ {v}_{c} = \frac{β {j}_{e} I {φ}_{p}}{h ( 1 - {φ}_{p} ) ( 1 - ɛ )} \qquad ( 10 )$$

The correlation value β is dependent upon particle-particle, particle-solvent, or particle-substrate interactions. Since the solvent molecule is assumed to flow more freely than the particle, the value β is assumed to be in the range of 0-1. Stronger interaction between particles or between the particle and the substrate results M smaller value of β. Also, for non-adsorbing particles and. dilute suspensions, β≈1.

Due to the difficulty of determining the jₑ of thin film materials experimentally, βjₑl can be converted to a single variable K, yielding:

$${v}_{c} = \frac{K {φ}_{p}}{h ( 1 - {φ}_{p} ) ( 1 - ɛ )} \qquad ( 11 )$$

For a monolayer of monodisperse spherical nanoparticles oriented in a closed packed hexagonal structure, 1−ε=0.605, and h equals the diameter of the spherical nanoparticles. The single variable K can then be calculated upon determination of ν_{c}.

A method of making a nanoparticle coated substrate using the deposition apparatus 1000 described above is also provided herein by way of example, as there are a variety of ways to carry out the method. The method described below can be carried out using the configurations illustrated in FIGS. 1 and 3-6, for example, and various elements of these figures are referenced in explaining an example method. The procedure described below is illustrative only and the order of the blocks can change according, to the present disclosure. Additional steps may be added or fewer steps may be utilized, without departing. from this disclosure.

First a substrate is secured to the platform. After securing the substrate, the deposition plate is placed above the substrate such that an acute angle is formed between the deposition plate and the substrate. Preferably, the acute angle formed by the substrate and deposition plate is greater than 25 degrees, more preferably greater than 45 degrees, and even more preferably the acute angle is 60 degrees. The acute angle is formed at an end of the substrate that is closest to the support member. In at least one embodiment, the deposition plate can be positioned, such that it contacts the substrate. In other embodiments, the deposition plate can be suspended above the substrate at while still forming the acute angle. In at least one embodiment, the deposition plate is suspended up to 0.5 mm above the substrate surface. In other embodiments, the deposition plate is suspended from about 40 μm to about 0.5 mm above the substrate surface.

A suspension comprising a solvent and nanoparticles is then applied to an area between the deposition plate and the substrate by continuous flow of the suspension such that the suspension contacts the deposition plate and substrate and forms a meniscus between the deposition plate and the substrate. The suspension is delivered is the inlet port 11 and outlet port 12 to the area between the deposition plate and the substrate. The continuous flow can be controlled by the user or by the continuous depletion of the meniscus during deposition. The suspension can have 1-50 volume of nanoparticles more preferably 20-50 volume %, and even more preferably about 40 volume %.

After applying the suspension between the deposition plate and substrate, the motor is actuated to drive the support member and deposition plate to move toward the end of the substrate away from the support member to spread the suspension along the surface of the substrate. The motor can drive the support member to move for a predetermined distance or the length of the substrate over a predetermined rate of speed. The deposition speed can range from 1 μm/s to 200 μm/s, preferably 20-100 μm/s, and even more preferably 60 μm/s. After spreading the suspension on the substrate, the suspension solvent is removed and the formed nanoparticle coated substrate is allowed to dry. Once removal of the solvent has been accomplished, the nanoparticle coated substrate can be removed from the platform.

The method is preferably carried out under ambient conditions ranging from 16-22° C., and more preferably 18° C., and in an environment having a relative humidity ranging from 35-55%.

A method of making a nanoparticle coated substrate using the deposition apparatus 2000 described above is also provided herein by way of example, as there are a variety of ways to carry out the method. The method described below can be carried out using the configurations illustrated in FIGS. 2-6 for example, and various elements of these figures are referenced in explaining an example method. The procedure described below is illustrative only and the order of the blocks can change according to the present disclosure. Additional steps may be added or fewer steps may be utilized, without departing from this disclosure.

First a substrate is secured to the platform. Miler securing the substrate, the deposition plate is placed above the substrate such that an acute angle is formed between the deposition plate and the substrate. Preferably, the acute angle formed by the substrate and deposition plate is greater than 25 degrees, more preferably greater than 45 degrees, and even more preferably the acute angle is 60 degrees. The acute angle is formed at an end of the substrate that is closest to the support member. In at least one embodiment, the deposition plate can be positioned such that it contacts the substrate, in other embodiments, the deposition plate can be suspended above the substrate at while still forming the acute angle. In at least one embodiment, the deposition plate is suspended up to 0.5 mm above the substrate surface. In other embodiments, the deposition plate is suspended from about 40 μm to about 0.5 mm above the substrate surface.

A suspension comprising a solvent and nanoparticles is then applied to an area between the deposition plate and the substrate by continuous flow of a nanoparticle containing suspension such that the suspension contacts the deposition plate and substrate and forms a meniscus between the deposition plate and the substrate. The nanoparticle suspension is delivered via the inlet ports and outlet ports to the area between the deposition plate and the substrate. The continuous flow can be controlled by the user or by the continuous depletion of the meniscus during deposition. The suspension can have 1-50 volume % of nanoparticles, more preferably 20-50 volume %, and even more preferably about 40 volume %.

After applying the suspension between the deposition plate and substrate, the motor is actuated to drive the platform to move in a direction opposite the acute angle formed between the deposition plate and the substrate to spread the suspension along the surface of the substrate. The motor can drive the platform to move for a predetermined distance or the length of the substrate over a predetermined rate of speed. The deposition speed can range from 1 μm/s to 200 μm/s, preferably 20-100 μm/s, and even more preferably 60 μm/s. After spreading the suspension on the substrate, the suspension solvent is removed and the formed nanoparticle coated substrate is allowed to dry. Once removal of the solvent has been accomplished, the nanoparticle coated substrate can be removed from the platform.

The method is preferably carried out under ambient conditions ranging from 16-22° C., and more preferably 18° C., and in an environment having a relative humidity ranging from 35-55%.

As shown in FIG. 7, the deposition plate 6 can have a plurality of channels 100 which extend in stages from the inlet 11 to a plurality of outlet ports 12. The suspension 9 can be provided at the inlet 11, which passes through the plurality of channels 100 and then exits the plurality of outlet ports 12. The channels 100 are provide through the deposition plate 6 in a tree pattern and which increase in number extending from the inlet 11 to the outlet ports 12. In particular, stages 101 through 106 each double in the number of channels 100 with each successive stage. For example, in the first stage 101, there is one channel. This stage 101 doubles to two channels 100 in stage 102. Each of the channels 100 in stage 102 doubles such that there are four channels 100 in stage 103. Successively, in the next. stage 104 each of the channels 100 in the previous stage double to eight channels in 104, sixteen channels 100 in stage 105, and thirty two channels 100 at stage 106. After stage 106, any provided suspension would then exit the plurality (thirty two in this case) of outlet ports 12.

By use of the channels 100, a wider area of a substrate can be coated by the deposition plate 6. Referring back to FIGS. 3 and 4, the inlet 11 can be placed at the top deposition plate 6 for receiving suspension 9. The suspension 9 is input into the inlet 11, and passes through the channels 100, and out the plurality of outlet ports 12. With each stage, the width of the plurality of outlet ports 12 from end to end increase, such that a wider area of a substrate can be coated. In some examples, the number of channel 100 increases exponentially at each stage. To avoid sedimentation of the nanoparticles in the channel, the coating plate can be aid with ultrasonic vibrator or other RF/optical methods, where the particles absorbs the wave energy and become more thermally active to avoid sedimentation. The inner surface of the channels can also be coated with various functional chemical agent that repels a particular nanoparticle used.

The channels 100 can have any cross-section shape, for example, circular, square, rectangular or other polygonal shape. Also, as shown in FIG. 7, the each of the individual channels 100 can decrease in size (i.e. diameter, radius, width), such that at each successive stage, the cross-sectional area of channels 100 are smaller. In particular, the size of the channels for each successive stage can follow Murray's law (for circular cross-section of the channel) or modified Murray's law for square cross sections or other shape). For example, the cross-section area of each sub daughter branch also follows Murray's law. Proportioning the size of the channels according to Murray's law can aid in optimizing flow through the channel system. For example, the radii can follow the following formula:

rₚ³32 r_{d1}³+r_{d2}³+r_{d3}³+ . . . +r_{dn}³

In this case, rₚ is the radius of the parent branch, i.e., the inlet channel.

As shown in FIG. 8, the top end 13 can have a plurality of inlets 11, each having a plurality of stages and channels 100, and ending at a plurality of outlet ports 12. By adding additional inlets at the top end 13, fewer stages can be employed while still achieving a broader area of coating. However, one may also combine all the inlets 11 to have a sole inlet. Furthermore, the lower end 14 can be angled to facilitate the coating process.

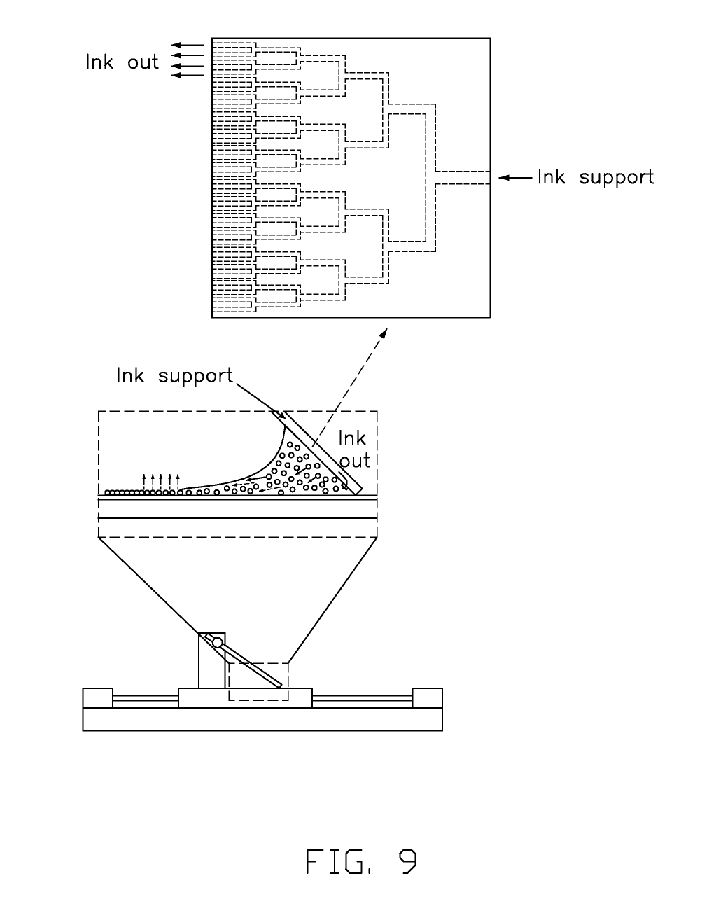

With reference to FIG. 9, there is shown how the deposition plate 6 with the plurality of channels 100 illustrated in FIG. 7 is incorporated in the deposition apparatus 2000 as illustrated in FIGS. 2 and 3. As shown, fluid (such as ink) enters the inlet 11, and exits the plurality of outlet ports 12 to coat the substrate 8 on the platform 20. In some examples, the suspension provision and coating can be conducted at a constant (continuous) speed, such that there is a constant flow of the suspension 9 at the outlet. Accordingly, a continuous process can be provided, where the suspension can be provided continuously to the inlets 11, and at a rate equal to particle assembly (coating) on the substrate and evaporation rate of the solvent.

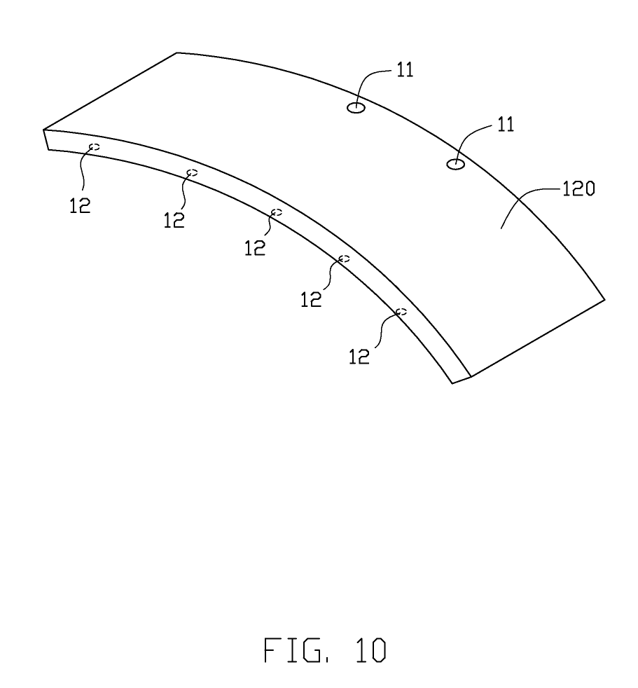

FIG. 10 is an exemplary illustration of a curved deposition plate 120. The curved deposition plate 120 can have a plurality of channels (not shown) formed as described with respect to FIGS. 7 and 8. The channels increase in number, doubles every stage from a plurality of inlets 11 to a plurality of outlet ports 12. In other examples, the channels do not double in number but are made up of a single channel from each of the plurality of inlets 11 to the plurality of outlet ports 12. The curved deposition plate 120 has a curved shape. The curved deposition plate 120 can also be described as having an arcuate shape. Such shape can aid in coating a curved substrate. In other examples, the deposition plate can have any other shape to conform to the shape of the substrate.

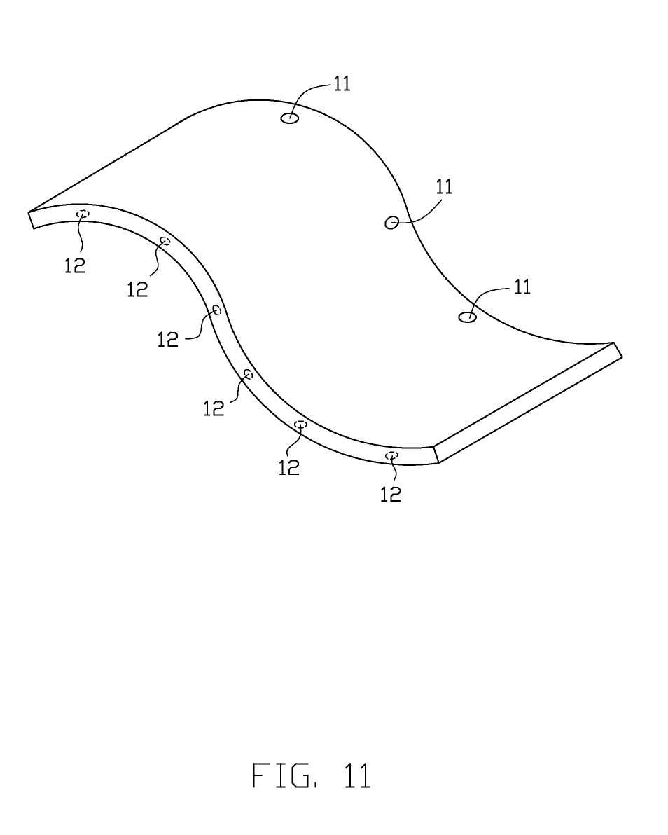

For example, as shown in FIG. 11 is an exemplary illustration of a curved deposition plate 121. The curved deposition plate 121 can have a first curve followed by an inverted curve, or a wave pattern, having a trough and a crest. The wave pattern can have repeated troughs and crests. The curved deposition plate 121 can have a plurality of channels (not shown) formed as described with respect to FIGS. 7-10. For example, the channels can increase in number from a plurality of inlets 11 to a plurality of outlet ports 12. For example, the channels can have a plurality of stages where the channels double at each successive stage. In other examples, the channels do not double in number but are made up of a single channel from each of the plurality of inlets 11 to the plurality of outlet ports 12. Such shape can aid in coating a curved substrate.

While not to be held to any particular hypothesis, the following derivation is provide to achieve a steady state continuous process.

To continuously supply suspension, consider the steady state of volume conservation

Jₘ=J_{M}+J_{P}+J_{S} (12)

With equations (2) and (6), the equation (12) can be rewritten as (wherein the subscript ink is an exemplary incoming coating suspension), and
Jₘₖ: the flux of of incoming ink supply
J_{M}: the flux of evaporating solvent from the meniscus
J_{E}: the flux of evaporating solvent from the drying film
J_{P}: the flux of particle
J_{S}: the flux of solvent

$$\begin{matrix}{J}_{ink} = {J}_{M} + {j}_{p} {h}_{f} \underline{y} + {j}_{s} {h}_{f} \underline{y} \\ = {J}_{M} + ( {N}_{p} {V}_{p} {v}_{p} ) {h}_{f} \underline{y} + ( {N}_{s} {V}_{s} {v}_{s} ) {h}_{f} \underline{y} \\ = {J}_{M} + ( {N}_{p} {V}_{p} {v}_{p} ) {h}_{f} \underline{y} + ( {N}_{s} {V}_{s} \frac{{v}_{p}}{β} ) {h}_{f} y \frac{{N}_{p} {V}_{p}}{{N}_{p} {V}_{p}} \\ = {J}_{M} + ( {N}_{p} {V}_{p} {v}_{p} ) {h}_{f} \underline{y} + ( {N}_{p} {V}_{p} \frac{{v}_{p}}{β} ) {h}_{f} \underline{y} \frac{{N}_{s} {V}_{s}}{{N}_{p} {V}_{p}} \\ = {J}_{M} + ( {N}_{p} {V}_{p} {v}_{p} ) {h}_{f} \underline{y} + \frac{1}{β} ( {N}_{p} {V}_{p} {v}_{p} ) {h}_{f} \underline{y} \frac{{N}_{s} {V}_{s}}{{N}_{p} {V}_{p}} \\ = {J}_{M} + {v}_{c} ( 1 - ɛ ) h \underline{y} + \frac{1}{β} {v}_{c} ( 1 - ɛ ) h \underline{y} \frac{1 - {φ}_{p}}{{φ}_{p}} \\ = {J}_{M} + {v}_{c} ( 1 - ɛ ) h \underline{y} ( 1 + \frac{1}{β} \frac{1 - {φ}_{p}}{{φ}_{p }} )\end{matrix} \qquad ( 13 )$$

For a coating area with width w, the unit length y in (13) should be replaced by to have

$${J}_{ink} = {J}_{M} + {v}_{c} ( 1 - ɛ ) hw ( 1 + \frac{1}{β} \frac{1 - {φ}_{p}}{{φ}_{p}} ) \qquad ( 14 )$$

where
ν_{c}: experimentally obtained
1−ε=0.605
h=D, the diameter of the colloidal partical
w: the desired coating width
β: value between 0-1, with most cases approaches 1
φ_{P}: the volume concentration of the colloidal ink

Note that one may have

$${J}_{ink , n Δ} = {J}_{M} + {v}_{c , n Δ} ( 1 - ɛ ) hw ( 1 + \frac{1}{β} \frac{1 - {φ}_{p}}{{φ}_{p}} ) , \\ n = 1 , 2 , 3 \qquad ( 15 )$$

Where

TABLE 1
Relation between Number of Layers,
Microsphere Packing Type (hexagonal Δor square □),
Film Thickness (h), and Packing Fraction (1-ε)^{a}

| n | film thickness, h | (1-ε) |
|---|---|---|
| 1Δ | D_{P} | 0.6046 |
| 2□ | 1.707 D_{P} | 0.6134 |
| 2Δ | 1.817 D_{P} | 0.6657 |
| 3□ | 2.414 D_{P} | 0.6506 |
| 3Δ | 2.633 D_{P} | 0.6889 |

One may design a deposition plate 6 that can continuously supply the colloidal ink with designed coating knife geometric profile and designed ambient environment (e.g. RH and T), such that the evaporation flux at the meniscus is much smaller comparing to the particle flux and solvent flux (which is equal to the evaporation flux J_{S}=J_{E}), namely J_{M}=J_{P}=J_{S}. Then, equation (15) can be simplified with better control, as

$${J}_{ink , n Δ} \approx {v}_{c , n Δ} ( 1 - ɛ ) hw ( 1 + \frac{1}{β} \frac{1 - {φ}_{p}}{{φ}_{p}} ) , \\ n = 1 , 2 , 3 \qquad ( 16 )$$

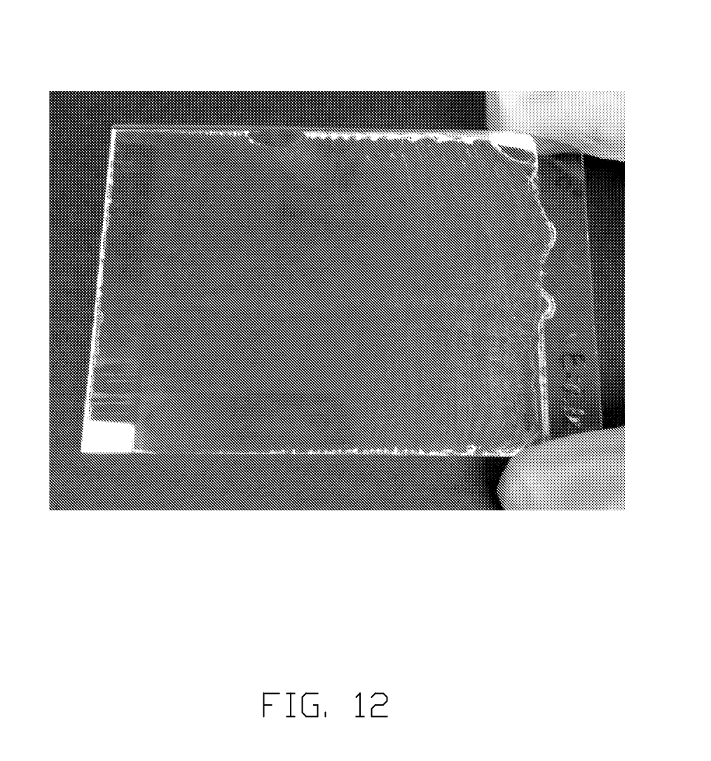

FIG. 12 illustrates an exemplary nanoparticle thin film coated on a substrate. The nanoparticle thin film was prepared by the methods outlined above using SiO₂nanoparticles. The substrate in FIG. 12 has a length of 5 cm and the deposition occurred over a 10 minute period. As shown, the thin film is uniform and exhibits semi-transparency.

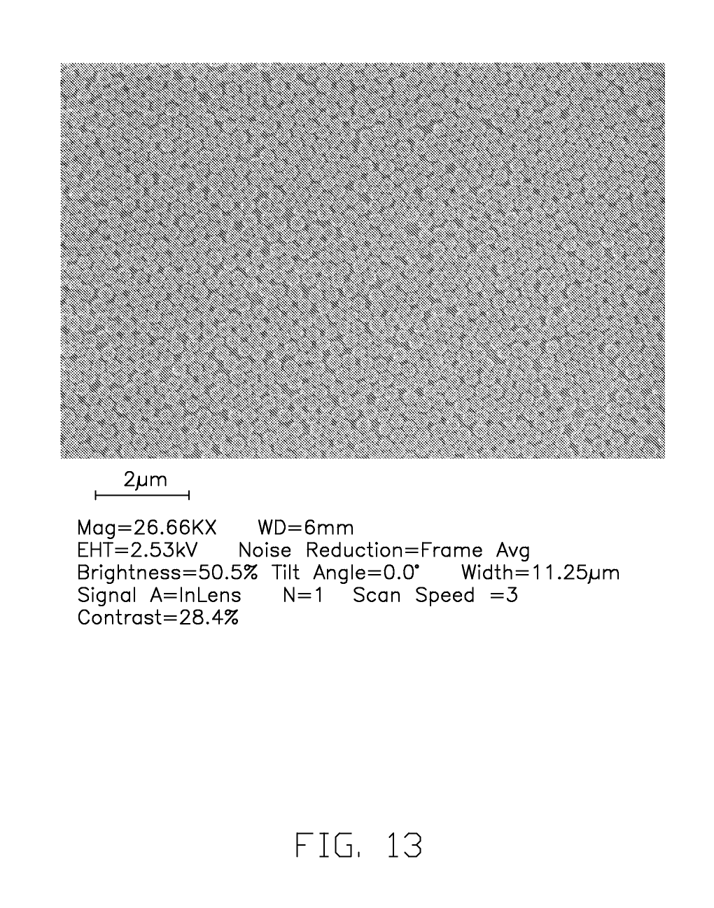

FIG. 13 illustrates a Scanning Electron Microscope (SEM) of a nanoparticle monolayer disposed on a substrate. The spherical SiO₂ nanoparticles range from about 240-360 nm in diameter. As shown, the nanoparticle monolayer exhibits regions of closed packed hexagonal structure with minor areas of dislocations or voids therethrough.

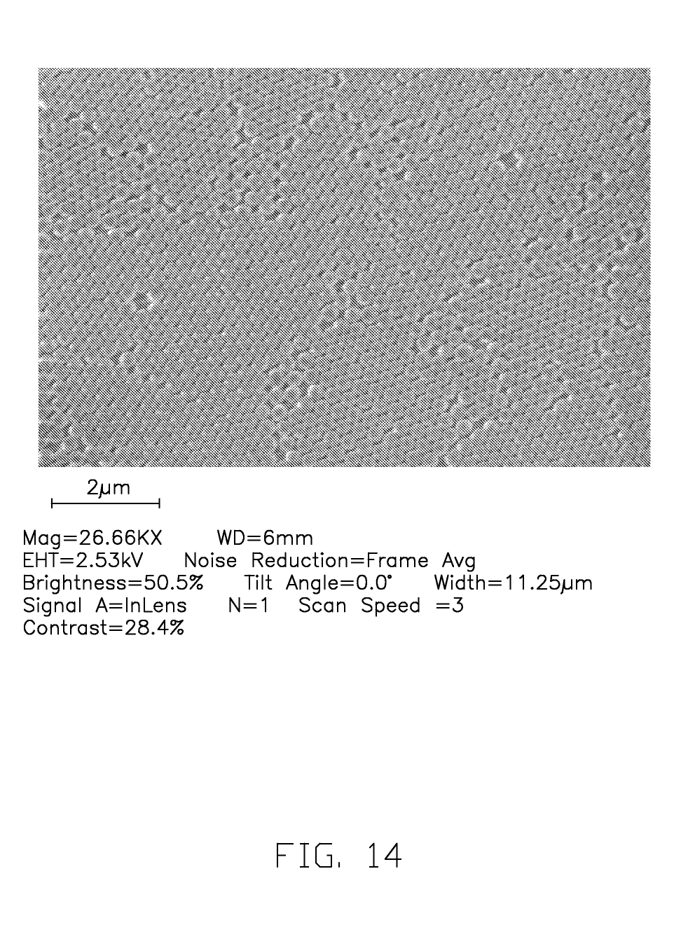

FIG. 14 illustrates an SEM image of another SiO₂ nanoparticle monolayer disposed on a substrate. The spherical nanoparticles range from about 240-360 nm in diameter. As shown, the nanoparticle monolayer exhibits a more highly ordered closed packed hexagonal structure than the nanoparticle monolayer of FIG. 13.

As shown, the monolayer of FIG. 14 exhibits more defined grain boundaries, meaning some line-defects are observed, while in the monolayer of FIG. 13, the lattice domain is smaller, rendering a more random patterning. These differences in lattice types of FIGS. 13 and 14 can be attributed to different variables which affect the self-assembly process, such as temperature, relative humidity, coating speed, particle volume density, etc.

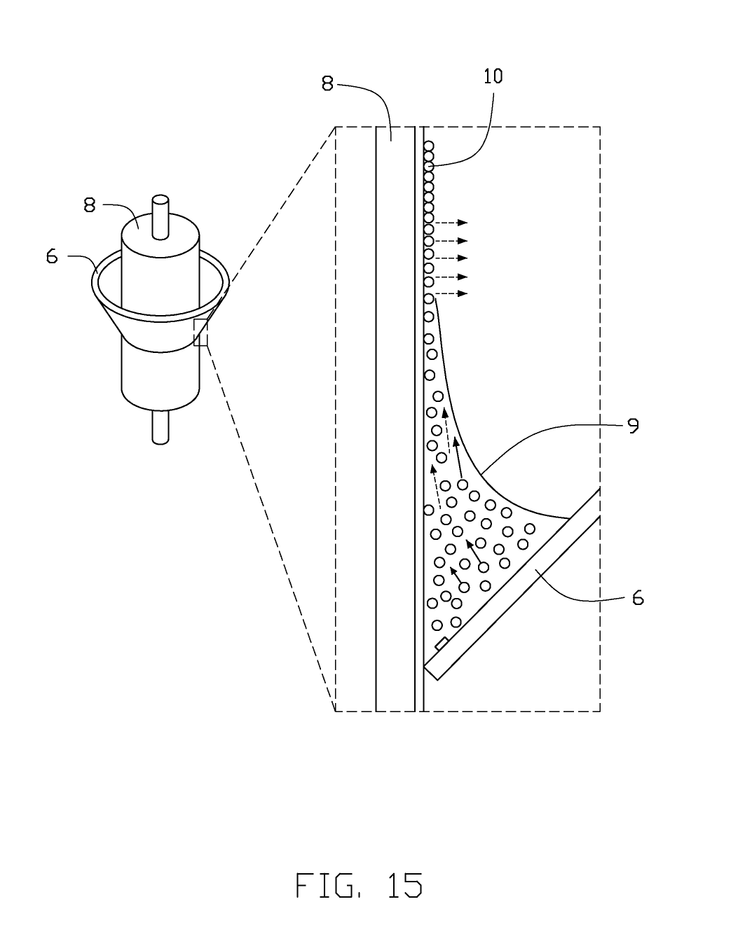

While the above illustrations provide details concerning a substantially planar surface, the present disclosure also contemplates implementation with a three dimensional object as well. The following FIGS. 15-20 and description take the fundamental teachings as recited above and apply them to a surface that is three-dimensional.

As shown in the exemplary embodiments and methods described above, the deposition plate 6 can be a flat plate. In alternative embodiments, the deposition plate 6 can be a plate that is configured to conformance fit to a three-dimensional substrate structure. FIG. 15 is a diagrammatic view illustrating the application of nanoparticles onto the surface of a cylindrical substrate using another exemplary deposition plate. As shown in FIG. 15, the deposition plate 6 can be substantially conical with an aperture configured to conformance fit the shape of the cylindrical substrate 8. It should be noted that, while only the deposition plate 6 is shown in FIG. 15, the deposition plate 6 can be coupled to the support member 4 of the nanoparticle deposition apparatus 1000 and used in one or more methods as described above with respect to the previously described figures. Also, the coating plate can continuously support nanomaterials.

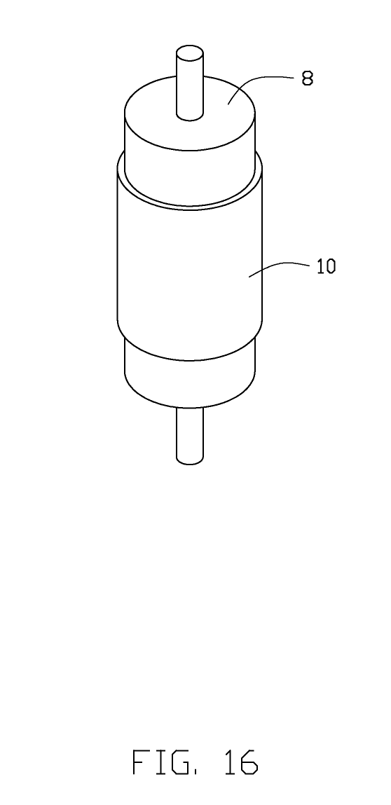

FIG. 16 is an exemplary cylindrical nanoparticle thin film coated substrate using the deposition plate illustrated in FIG. 15.

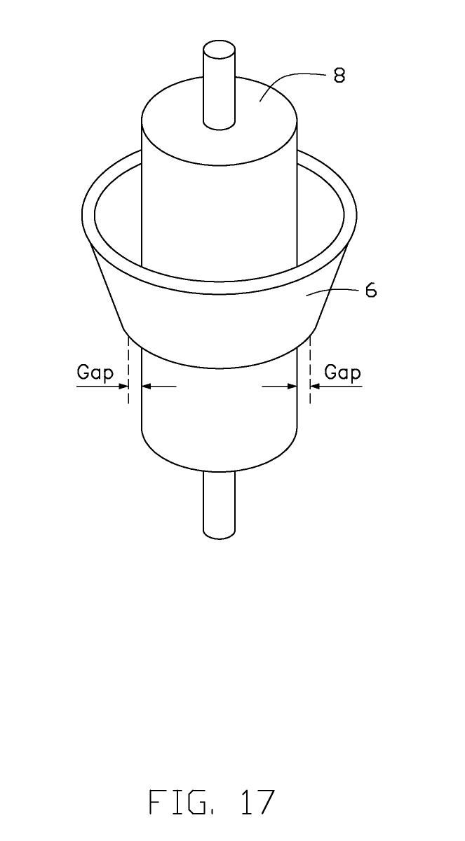

FIG. 17 illustrates an exemplary embodiment similar to the one illustrated in FIG. 15, but the embodiment illustrated in FIG. 17 includes a gap formed between the deposition plate 6 and the substrate 8. The deposition plate 6 can be substantially conical with an aperture configured to conformance fit the shape of the cylindrical substrate 8. it should be noted that, while only the deposition plate 6 is shown in FIG. 17, the deposition plate 6 can be coupled to the support member 4 of the nanoparticle deposition apparatus 1000 and used in one or more methods as described above with respect to the previously described figures.

In at least one embodiment, a spacer can be coupled to the deposition plate between the deposition plate and the substrate. The spacer can be configured to be flexible or rigid. When the spacer is configured to be flexible it allows for a conformance fit to the substrate. The spacer can be a flexible member that allows for a conformance fit to the substrate so as to establish a consistent gap being formed.

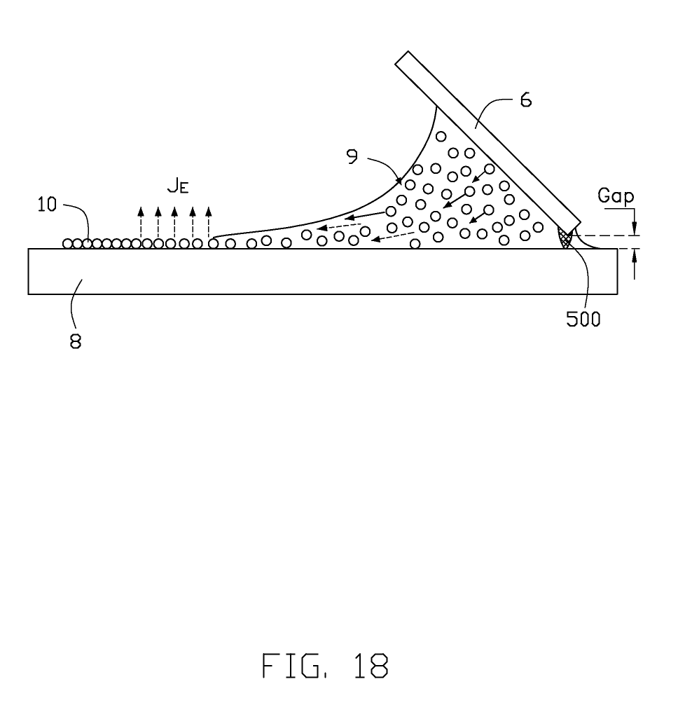

FIG. 18 illustrates a cross sectional view with a spacer 500 and a gap being illustrated. The spacer 500 can be a flexible member that allows for a conformance fit to the substrate so as to establish a consistent gap being formed. The gap can be in the form of an annulus when the substrate is substantially cylindrical. In other embodiments, the gap 600 follows the three dimensional substrate.

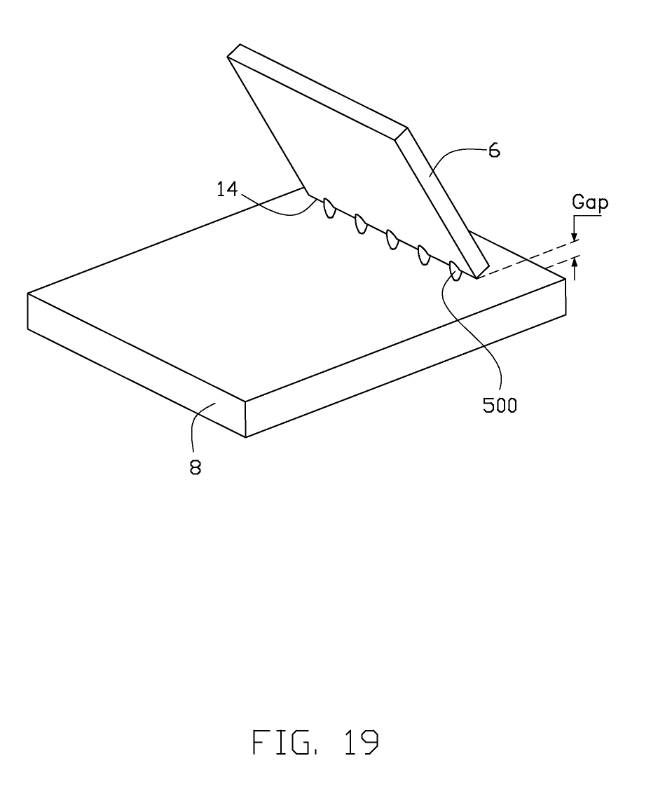

FIG. 19 illustrates another example of the deposition plate 6. The deposition plate 6 can be formed so as to include the channels (not shown). Additionally, to plurality of spacers 500 can be coupled to the deposition plate 6. The spacers 500 can be configured to be flexible or rigid. When the spacers 500 are configured to be flexible it allows for a conformance fit to the substrate 8.

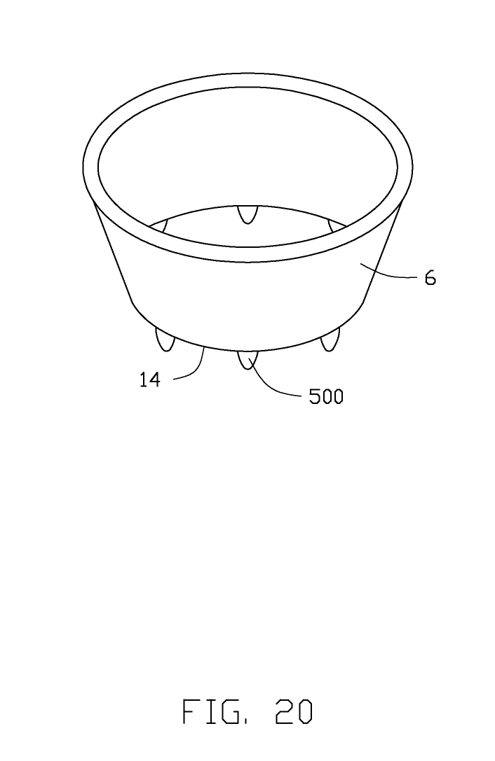

FIG. 20 illustrates the implementation as illustrated in FIG. 19, but in a substantially conical configuration like that of FIGS. 15 and 17 as described above.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the part Within the principles of the present disclosure up to, and including, the full extent established by the broad general meaning of the terms used in the claims.

What is claimed is:

1. An apparatus for applying nanoparticles to a surface of a substrate, the apparatus comprising:
a support member;
a deposition plate extending from the support member, the deposition plate defining a plurality of channels therein, the channels having at least one inlet and a plurality of outlet ports, the plurality of outlet ports being adjacent to a lower end of the deposition plate; and
a platform for receiving the substrate,
wherein the support member and the platform are capable of moving relative to each other, enabling the lower end of the deposition plate to move across the surface of the platform.

2. The apparatus of claim 1, wherein the apparatus further comprises a motor, the motor is coupled to the support member and is configured to drive the support member to move relative to the platform, or the motor is coupled to the platform and is configured to drive the platform to move relative to the deposition plate.

3. The apparatus of claim 1, wherein the apparatus further comprises a drive shaft, the support member or the platform is capable of moving along the drive shaft.

4. The apparatus of claims 1, wherein the apparatus further comprises a clamp mounted on the support member, the clamp couples to the deposition plate.

5. The apparatus of claim 1, wherein the deposition plate has a three-dimensional shape fitting the shape of the substrate.

6. The apparatus of claim 1, wherein the deposition plate is made of deformable material, and is able to be formed into a shape conforming to the surface of the substrate for deposition of nanoparticles.

7. The apparatus of claim 1, wherein the channels have a plurality of stages between the at least one inlet and the plurality of outlet ports, each channel doubles in the number each at successive stage, and the size of the channels decreases at each successive stage from the at least one inlet to the outlet ports.

8. The apparatus of claim 1, wherein the deposition plate having a top surface and a under surface opposite to the top surface, the plurality of outlet ports define in the under surface, and the at least one inlet defines in a top surface adjacent to an upper end of the deposition plate opposite to the lower end of the deposition plate.

9. The apparatus of claim 1, wherein the deposition plate extends toward the surface of the platform at an acute angle greater than 25 degrees.

10. The apparatus of claim 9, wherein the acute angle is 60 degrees.

11. The apparatus of claim 1, wherein the lower end of the deposition plate physically contacts the substrate when the support member and the platform move relative to each other.

12. The apparatus of claim 1, wherein the lower end of the deposition plate is suspended above the substrate when the support member and the platform move relative to each other.

13. The apparatus of claim 12, wherein the lower end of the deposition plate is suspended from about 40 μm to about 0.5 mm above surface of the substrate.

14. The apparatus of claim 1, wherein at least one spacer is coupled to the lower end of the deposition plate to establish a gap between the deposition plate and the substrate.

15. A method of coating a substrate with a plurality of nanoparticles using an apparatus, the apparatus comprises a support member, a deposition plate extending from the support member, the deposition plate defining a plurality of channels therein, the channels having at least one inlet and a plurality of outlet ports, the plurality of outlet ports being adjacent to a lower end of the deposition plate; and a platform for receiving, the substrate, wherein the support member and the platform are capable of moving relative to each other, enabling the lower end of the deposition plate to move across the surface of the platform,
the method comprising:
securing a substrate on the platform:
forming an acute angle between the deposition plate and the substrate;
applying a suspension comprising a solvent and nanoparticles to the at least one inlet to allow the suspension pass through the channels and exit out from the outlet ports, and the suspension forming at least one meniscus between the deposition plate and the substrate;
driving the deposition plate to move relative to the platform or driving the platform to move relative to the deposition plate, enabling the suspension to spread on a surface of the substrate; and
removing the suspension solvent on the substrate.

16. The method of claim 15, wherein the suspension comprises about 1%-50% nanoparticles by volume.

17. The method of claim 15, wherein the acute angle is greater than 25 degrees.

18. The method of claim 17, wherein the acute angle is 60 degrees.

19. The method of claim 15, wherein the lower end of the deposition plate is suspended above the substrate.

20. The method of claim 15, wherein the lower end of the deposition plate physically contacts the substrate.
